(19) United States
(12) Patent Application Publication
(10) Pub. No.: US 2020/0276634 A1
(43) Pub. Date: Sep. 3, 2020

(54) METHOD FOR PRODUCING A CERAMIC CORE FOR THE PRODUCTION OF A CASTING HAVING HOLLOW STRUCTURES AND A CERAMIC CORE

(71) Applicant: FLC Flowcastings GmbH, Trebur (DE)

(72) Inventors: Wolfram Beele, Nierstein (DE); Heikko Schilling, Trebur (DE)

(21) Appl. No.: 16/753,744

(22) PCT Filed: Oct. 4, 2018
(86) PCT No.: PCT/EP2018/076975

§ 371 Date: Apr. 3, 2020

(30) Foreign Application Priority Data
Oct. 4, 2017 (DE) 10 2017 122 973.6

(51) Int. Cl. B22C 9/10; B28B 1/00; B33Y 10/00; B33Y 80/00; B22C 9/04; B22C 9/18; B28B 7/34

(52) U.S. Cl. CPC B22C 9/10; B28B 1/001; B33Y 10/00; B28B 7/346; B22C 9/043; B22C 9/18; B33Y 80/00

(57) ABSTRACT

A method for producing a ceramic core, and such a core, for preparing the production of a casting having hollow structures. The ceramic core configured to form, making use of a 3D model of digital geometric co-ordinates of the casting. The method involves unpressurized or low-pressure casting of a ceramic core blank, and specifically with an oversize relative to the core according to the geometric co-ordinates, and CNC processing of the core in accordance with the 3D model in a first CNC processing method.

This invention relates to a method in the sector of precision casting for producing a ceramic core for preparation for the production, by means of a ceramic mould, of a casting having hollow structures, which the ceramic core is configured to form, making use of a 3D model of digital geometric co-ordinates of the casting and of the ceramic core.

It is known that precision casting takes place with the use of a lost model in a lost mould, which is formed in the form of a ceramic coating, of one single use, of the model. The known method comprises the following steps:
Production of a positive model (in the same form as the casting which is to be produced) from a hard or elastic material;
Production of a temporary mould by pouring a fluid over the model and cooling it until it solidifies;
Extracting the model;
Forming a temporary model by pouring a second fluid into the cavity of the temporary mould and cooling until it solidifies;
Melting or dissolving the temporary mould;
Ceramic coating of the temporary model, in order to form a solid ceramic shell around the temporary model;
Melting or dissolving the temporary model and evacuating the fluid thereby incurred from the ceramic shell;
Filling the cavity of the shell with molten metal and allowing this to solidify, in order thereby to form the final casting.

Specifically, precision casting of hollow metal parts is a lost-mould method, and is also designated as the lost-wax process. The manufacturing process then takes place in a typical industrial manner with the following steps:
1. A core made of ceramic material is obtained by ceramic injection moulding (CIM) into a multi-part reusable injection mould, and by subsequent releasing, burning, and finishing. The core forms, in a complementary form (as a negative), the geometry of the cavity in the later casting.
2. A wax model is produced around the core by wax injection moulding into a multi-part reusable injection mould. The core is in this situation laid into the wax injection mould. The wax model forms the outer contour of the metal part which is to be cast.
3. The wax model, together with the core, or a plurality of such wax models, are supplemented to form a structure (a wax cluster) of a complete casting cluster, specifically with feeders (sprues or lugs) and casting gates, as well as filters, and, in the case of DS and SX casting, for example, with starters, nucleus selectors, and nucleus conductors.
4. A ceramic shell is formed on the wax cluster by immersing in a ceramic suspension (slips) and subsequent sanding and drying. Immersing, sanding and drying are repeated several times until the required shell thickness has been attained.
5. The wax model is melted out of the shell, typically in a steam autoclave under high pressure.
6. The shell is burned at temperatures of between 700° C. and 1100° C. As a result, wax residues and other organic substances are burned out, and the ceramic shell material attains the strength required. By inspection and adjustment as necessary it is ensured that the shell is free of any damage.
7. Molten metal is poured into the shell. The metal then solidifies and further cooling takes place.
8. The shell is removed from the castings, specifically by chemical leaching and mechanical processing. The components are separated from the gating system.
9. The core is removed from the cavity of the metal casting by chemical leaching in a pressure autoclave.
10. All residues of superfluous metal are removed from the component.

Most manufacturers of gas turbines work on improving multi-walled and thin-walled gas turbine blades made of superalloys. These comprise complicated air cooling channels in order to improve the efficiency of the internal cooling of the blades, such as to allow for greater thrust and achieve a satisfactory service life. The U.S. Pat. Nos. 5,295,530 and 5,545,003, relate to improved multi-walled and thin-walled gas turbine blade designs, which for this purpose comprise complicated air cooling channels.

The method according to the invention improves the production of all types of high-quality castings, since it makes it possible, regardless of their complexity and the geometry precision required, to form a lost model in a lost mould with lost cores without the need to use moulds for moulding to produce the cores, which form the geometry of the cores directly, as is usually done by means of ceramic injection moulding (CIM).

Precision casting is one of the oldest known original moulding processes, which was first used thousands of years ago in order to produce detailed works of art from metals such as copper, bronze, and gold. Industrial precision casting became commonplace in the 1940's, when the Second World War increased the demand for dimensionally-precise components made from specialised metal alloys. Nowadays precision casting is frequently used in the aviation and energy industries in order to manufacture gas turbine components such as blades and fins, with complex shapes and internal cooling channel geometry.

The production of a gas turbine rotor blade or guide blade from a precision casting usually involves the production of a ceramic casting mould, with an outer ceramic shell with an inner surface which corresponds to the shape of the blade, and with one or more ceramic cores positioned inside the outer ceramic shell, corresponding to the internal cooling channels which are to be formed inside the carrying surface. Molten alloy is poured into the ceramic casting mould, then cools and hardens. The outer ceramic shell and the ceramic core(s) are then removed by mechanical or chemical means, in order to release the cast blade sheet with the external profile shape and the cavities of the internal cooling channels (in the form of the ceramic core(s)).

There are a large number of techniques for the forming of mould inserts and cores, with geometries and dimensions which are of very considerable complexity and rich in detail. An equally varied array of techniques are used in order to position the inserts in the mould and keep them in place. The most widespread technique for holding cores in mould arrangements is the positioning of small ceramic pin inserts, which can be formed as one piece with the mould or the core or both, and which project from the surface of the mould to the surface of the core and serve to position the core insert and support it. After the casting process, the holes in the casting are filled, for example by welding or a similar method, preferably with the alloy from which the casting has been formed.

The ceramic core is typically brought into the desired core form by injection moulding, CIM, or transfer moulding of ceramic core material. The ceramic core material comprises one or more ceramic powders, a binding agent, and optional additives, which are poured into a correspondingly shaped core mould.

A ceramic core is usually produced by means of injection moulding, in that, first, the desired core shape is formed in corresponding casting mould halves of the core made of hardened wear-resistant steel by precision machining, and the mould halves are then brought together to form an injection volume which corresponds to the desired core shape, whereupon the injection of ceramic moulding compound into the injection volume takes place under pressure.

The moulding compound contains, as already indicated, a mixture of ceramic powder and binding agent. After the ceramic moulding compound has hardened to a “preform”, the mould halves are separated in order to release the preform.

After the preform core has been removed from the mould, it is burned at high temperature, in one or more steps, in order to remove the volatile binding agent and to sinter and harden the core, and specifically for use with the casting of metallic material, such as of a superalloy based on nickel or cobalt. These are normally used to cast single-crystal gas turbine blades.

At the casting of the hollow gas turbine blades with inner cooling channels, the burned ceramic core is positioned into a ceramic precision casting mould in order to form the internal cooling channels in the casting component. The burned ceramic core in the precision casting of hollow blades typically has a flow-optimised contour with an inflow edge and an outflow edge of thin cross-section. Between these front and rear edge regions the core can comprise longitudinal openings, although they may also be of other shapes, in order thereby to form inner walls, steps, deflections, ribs, and similar profiles, for delimiting and producing the cooling channels in the cast turbine blade.

At the production of the outer mould shell, the burned ceramic core is then used in the known lost-wax casting, wherein the ceramic core is arranged in a model casting mould, and a lost model is formed around the core, specifically by injection under pressure of model material such as wax, thermoplastic material, or the like into the mould, into the space between the core and the inner walls of the mould.

The complete casting mould made of ceramics is formed by positioning the ceramic core inside the two assembled halves of another mould made of precision-machined hardened steel (designated as the wax model mould or wax model moulding tool), which defines an injection volume which corresponds to the desired shape of the blade, in order then to inject molten wax into the wax model mould around the ceramic core. When the wax has hardened, the halves of the wax model mould are separated and removed, and they yield up the ceramic core, surrounded by a wax model which now corresponds to the shape of the blade.

The temporary model, with the ceramic core in it, is repeatedly subjected to steps for building up the shell mould thereon.

For example, the model/core module is repeatedly immersed in ceramic slip, with superfluous slip being allowed to drain off, sanded with ceramic pieces, and then air-dried, in order to build up several ceramic layers which form the mould shell on the arrangement. The resulting enrobed model/core arrangement is then subjected to the step of removing the model, for example by means of a steam autoclave, in order specifically to remove the temporary or lost model, such that the mould shell, with the ceramic core arranged inside it, then remains over. The mould shell is then burned at high temperature in order to produce an appropriate hardness and strength of the mould shell for the metal casting.

Molten metallic material, such as a superalloy based on nickel or cobalt, is poured into the pre-heated shell mould and allowed to harden in order to produce a casting with a polycrystalline or monocrystalline grain. The resulting cast blade sheet still contains the ceramic core, in order, after removal of the core, to form the internal cooling channels. The core can be removed by washing out, or by other conventional techniques. The hollow cast metallic flow-profile casting component then comes into being.

This known precision casting method is expensive and time-consuming. The development of a new blade design is typically associated with many months and hundreds of thousands of Dollars of investments. In addition to that, design decisions are limited by process-incurred restrictions on the production of ceramic cores, due, for example, to their fragility, as well as due to the time-consuming production of cores rich in detail or of large size. The metal processing industry has indeed recognised these limits, and has at least developed a number of gradual improvements, such as, for example, the improved method for casting cooling channels on a blade outflow edge in U.S. Pat. No. 7,438,527. However, because the market is constantly demanding greater efficiency and higher performance from gas turbines, the limits of existing precision casting processes are becoming ever more problematic.

Precision casting techniques are prone to a range of imprecisions. While imprecisions on the outer contour can often be corrected with conventional machining techniques, those involving internal structural shapes of cores are difficult, and often even impossible, to eliminate.

Internal imprecisions derive from known factors. These are, as a rule, imprecisions in the production of the core structure, imprecisions in the injection around the core in the wax mould during manufacture, assembly of the mould, unexpected changes or defects due to fatigue of the ceramic moulds and failures of the shell, the core, or of the securing elements during the manufacture, assembly, and handling before or during the casting process.

The precise design concept, dimensioning, and positioning of the core insert has become the most difficult problem in the production of moulds. These aspects of precision casting form the basis of the invention, although the method of this present invention can also be used in other technologies.

Typically, the production of the casting mould and core is restricted in the possibilities of reliably forming fine details with adequate resolution. With regard to the precision of positioning, of reliable dimensions, and of the production of complex and richly detailed moulds, the known systems are very limited.

The core inserts are, as a rule, shaped or moulded parts which are produced with the use of conventional injection or moulding of ceramics, followed by suitable burning techniques. It is in the nature of these ceramic cores that the precision is substantially less than can be achieved, for example, in metal casting processes. There is far greater shrinkage in the conventional ceramic casting compositions, or faults such as a substantial inclination to crack formation, blisters, and other defects. There is accordingly a high defect and rejection rate, deriving from shortcomings which cannot be corrected and which are caused in turn by defective cores and incorrect core positioning. In any event, at least a high degree of effort and expenditure is required to correct the casting components which lie outside the tolerances, if they actually can be corrected by way of subsequent machining, grinding, and the like. The productivity and efficiency of the precision casting process is substantially limited by these restrictions.

A further limiting aspect of precision casting has always been the considerable run-up period for the development of moulds and mould tools, usually of metal, for the cores and the temporary model, as well as the high degree of effort and expenditure associated with this. The development of the individual phases of the mould and mould tools, including in particular the geometry and dimensions of the wax moulds, the geometry and dimensions of the preform, and the final geometry of the burned moulds, in particular of the cores, and the resulting configuration and dimensioning of the casting produced in these moulds, are dependent on a large number of variables, including warpage, shrinkage, and crack formation during the different production steps, and in particular during the burning of the ceramic preforms. As the person skilled in this field of art is well aware, these parameters cannot be precisely foreseen, and the development of precision casting moulds is a highly iterative and empirical process of trial and error, which for complex casting components typically extends over a period of 20 to 50 weeks before the process can be taken into operation.

It follows from this that complex precision casting of hollow bodies, in particular for the production of individual parts, is restricted, and casting in substantial unit numbers is, as a rule, not possible due to the limited cycle numbers of the process and its elements, in particular of the moulds and mould tools. Changes in the design of the casting components require subsequent machining and processing of the moulds and tools on a corresponding scale, and are therefore very expensive and time-consuming.

The prior art has devoted attention to these problems, and has made progress in the use of improved ceramic compositions, which to a certain degree reduce the occurrence of such problems.

Although these techniques have led to improvements, they have been at the expense of the costs of the casting process, and nevertheless still do not achieve all the improvements required.

With regard to those techniques which involve an effect on the preforms, and in particular mechanical processing of the preforms, experience has shown that the changes in the dimensions during the burning of the ceramic bodies still continually cause a series of imprecisions which restrict the attainment of the geometry and dimensions of the burned bodies which are being striven for. Due to the fragility of the preforms, the techniques which can be used are in themselves limited, and, as a rule, a substantial amount of manual work is required. Even with the best precautionary measures and the greatest care, a substantial proportion of the cores are, in the end, destroyed by the work processes.

However, particularly disadvantageously, the efforts from the prior art, even the most recent, have achieved little towards improving the cycle time of the development of moulds and mould tools, or reducing the number of repeated operations required, which are necessary for producing the final moulds and mould tools with the required precision of shape and dimensions. The prior art has not provided any effective techniques for reworking the shapes of shells and cores which are outside the specifications, or for changing the moulds to meet design changes, without starting again with the mould and mould tool development process.

As already indicated, casting cores are conventionally produced in accordance with the CIM method (Ceramic Injection Moulding). A ceramic “feedstock”, which is plasticised by means of the admixing of wax and other additives, is injected under pressure into an injection moulding mould. The complete geometry of the core is formed by the injection moulding mould. After demoulding, the core is released and burned at a specific temperature curve (burning temperature typically between 1000° C. and 1300° C.).

Finishing of the cores, for example for the removal of flash or for other corrective measures, as may be required, can be carried out, as is known, in different ways:
Finishing is typically carried out manually, with diamond grinding tools.
CNC-supported finishing with diamond grinding tools is likewise known. In this situation, the cores are fixed in a device by mechanical clamping.
Also known is a partial creation of specific geometric details of casting cores by CNC milling. In this situation, casting cores are prepared in accordance with the CIM process, wherein specific geometric details are included in the form of additional machining, in order to allow for subsequent completion by CNC milling.

This has the following disadvantages: With traditional core production by CIM, the moulding of cores takes place in the end contour, as a preform. A subsequent debinding and burning process is necessary in order to achieve the desired properties of the core material. In this situation, the cores experience deformation due to shrinkage effects, caused by the release of internal stresses and possible loading under the dead weight of the moulding. A typical effect which in this situation leads to dimensional deviations and the rejection of casting cores is warping (torsion) of the geometry.

As well as this, core production by CIM (Ceramic Injection Moulding) requires the use of highly-complex injection moulding moulds and tools. The high complexity of the moulds and tools accords with the complicated cooling circuit arrangements (for example, serpentines, turbulators, outlet channels, etc.) in the interiors of high-pressure turbine blades. The production of these moulds and tools is associated with high costs (not unusually several hundreds of thousands of Euros) and long run-up times (usually of several months), until a mould or tool is available for a new component geometry. Casting plant products (rotating and static high-pressure turbine blades) for the construction, for example, of gas turbines are consequently only available after a period of typically one to two years. Repeated adjustments of the component geometry often lead, in the structural design process, to a necessary change to the mould or tool, which in turn requires a correspondingly long time. A shortening of the repeated geometry adjustments can, in particular, contribute to shortening the development cycles of gas turbines, and manufacturers of gas turbines are therefore able to react more rapidly to the changing requirements of the market.

In WO 2015/051 916 A1 a method is described for the precision casting of hollow components. In this method, a casting core is produced from a blank of ceramic material by subtractive means using CNC processing. The ceramic blank material is already in a burned state, and, after the production of the end contour by CNC processing, requires no further burning. Following this, the core is embedded in model wax, and the wax model outer contour is produced in turn by CNC processing. The congruent positioning of the co-ordinate systems of core and wax model, within tolerances of +/−0.05 mm or better, is ensured by the special mechanical structure of the CNC processing device.

The advantages of this technology consisted, among others, of the fact that, for the production of wax models with ceramic cores which are suitable for precision casting, no highly complex and highly precise injection moulding moulds and tools were required any longer, which directly reproduce the component geometry, which as a result means that the associated costs and run-up times could be avoided. The CIM-produced core blank could be provided with larger contours, since more complex geometries could be produced in a precise manner in the later CNC step. Additionally, due to the direct CNC processing of the core into the end contour, dimensional distortions and waste were already avoided, such as occurred with the conventional previous (and also still present day) production of the core by CIM. The blank, however, according to this improved technology of the prior art, as indicated, was still produced, as usual, by means of CIM.

One object of the present invention is to provide a method for producing precision casting moulds with moulded cores, as well as the moulded cores themselves, with improved reproducibility, dimensional stability, precision, and speed of production.

This object is solved by a method with the features of claim 1 and a core with the features of claim 2. Preferred embodiments are presented in the subclaims.

According to the invention, a method is used for the production of casting cores, in particular with complex geometries, for use in the precision casting of hollow metal components. Casting cores are used in order to reproduce the geometry of the cavities in the interior of the component, such as, for example, the courses of cooling circuits with complex geometries.

The production of the casting cores without tools, according to the invention, does not require any injection moulds and moulding tools. The shaping takes place by CNC milling from blanks, in particular blanks which are not close to the final shape, made from suitable ceramic material. The blanks are prepared, for example, by slip casting from aqueous ceramic suspensions and subsequent burning of the ceramic mould bodies. The CIM method which is usually applied in traditional casting techniques is not used for the production of cores.

The method presented provides significant advantages in comparison with the traditional method, with regard to the run-up period, with which, for example, first casting cores with altered geometries can be produced, as well as with regard to the dimension tolerances of the casting cores produced.

According to the invention, therefore, a method is provided for producing a ceramic core for preparing for the production of a casting, as well as of its ceramic core, having hollow structures, which is configured for the moulding of the ceramic core, using a 3D model of digital geometric co-ordinates of the casting, wherein the method comprises the following steps:
a) Unpressurized or low-pressure casting of a ceramic core blank, and specifically with an oversize relative to the core according to the geometric co-ordinates;
b) Positioning of the core blank in a processing holding device;
c) CNC processing of the core according to the 3D model in a first CNC processing method.

Preferably, the method and the core are characterized in that step a) is carried out by means of slip casting, pressure slip casting, cold isostatic pressing, hot isostatic pressing, uniaxial pressing, hot casting, low-pressure injection moulding, gel casting, or extruding, and/or that in step a) the first CNC production process is CNC milling or a generative manufacturing process, such as, for example, 3D printing, or selective laser melting or sintering.

Preferably, the further method comprises the following steps:
d) Maintaining the positioning or renewed positioning of the core in a processing holding device;
e) Casting of model material around the core into a volume greater than the cubic dimensions of the casting component, which is spatially determined in accordance with the 3D model by the position of the core in the processing holding device, and allowing the model material to solidify;
f) CNC production of an outer contour of a lost model of the casting component from the solidified model material around the core in accordance with the 3D model, in a second CNC processing method;
g) Application of a ceramic mould onto the outer contour of the lost model and formation of a positioning connection of the ceramic mould with the processing holding device;
h) Removal of the lost model from the ceramic mould around the core in the processing holding device;
i) Pouring of metal into the ceramic mould around the core in the processing holding device;
j) Hardening of the molten metal to form the solid casting component, and
k) Removal of the ceramic mould and of the core from the casting component.

The attainment of the casting core geometry and/or end contour can therefore, according to the invention, take place completely and exclusively by CNC processing. The production of the blank takes place preferably by the slip casting of aqueous ceramic suspensions, with subsequent drying and burning.

A ceramic core material, which is suitable for use with SX (Single Crystal), DS (Directional Solidification), or equiaxed vacuum precision casting, is produced from known raw materials. The properties of mechanical strength, resistance to high temperature, thermomechanical behaviour from room temperature to above 1550° C., such as dilatometry and creep resistance, porosity, and solubility in concentrated alkali, can be adjusted in a suitable manner such that the proportions and particle size distributions of the individual mineral components can be adjusted in a suitable manner. In particular, by way of the mineralogical composition in conjunction with the firing curve, the formation of cristobalite as a consequence of the crystallization of the main component fused silica is restricted to a low level.

The geometry of the blanks does not need to be close to the end contour. Preferably, the blank has a processing allowance, in particular in relation to all places of the end contour relevant as to geometry, of 1 mm or more.

Advantageously, the geometry of the blanks can be optimised for the best possible uniform and reproducible ceramic properties.

The feedstock for the moulding of the blanks can be a water-based ceramic suspension (“slips”, although other solvents are also possible). These are mixed from the individual raw material components of the ceramic core material, namely several ceramic raw materials which are usually in powder form, in particular fused silica as main component, as well as other oxides and organic additives.

The shaping of the blanks is carried out not as in traditional casting core production by CIM, but by unpressurized or low-pressure casting in gypsum moulds. A further possibility, namely a low-pressure casting technique, is therefore, according to the invention, pressure slip casting, for example in moulds of a porous plastic with a pressure slip casting machine. Other possible methods are, for example, CIP (Cold lsostatic Pressing), hot casting, low-pressure injection moulding, gel casting, or dry pressing.

Preferably, therefore, the ceramic moulding bodies are then dried and burned in accordance with a defined temperature curve. Burning temperatures amount typically to between 1000° C. and 1300° C. The ceramic moulding bodies thereby obtain their properties of density, porosity, and mechanical strength in the required manner. Water and all organic additives are thereby removed. The moulding bodies obtained in this way exhibit, in comparison with the prior art, a perceptibly better and homogeneous structure, and low internal stresses, or even free of them altogether. This freedom from shrinkage holes and cavities, and the favourable internal stress condition are ideal preconditions for successful CNC processing.

The properties of density, porosity, and mechanical strength of the burned blanks can be specifically modified by the appropriate additives in suitable concentration in the ceramic suspension (feedstock, slips). This allows for the raw material to be adjusted, in order to allow for treatment by CNC processing and also in the subsequent precision casting process, and for optimisation.

Locally, too, the properties of density, porosity, and mechanical strength of the burned blanks can be adjusted specifically. This allows for the raw material to be adjusted locally also, in order for the treatment by CNC processing and in the subsequent precision casting process to take place altogether in sections, and to be optimised. For the local adjustment of the properties of the burned blanks, among other procedures, treatment with organic or inorganic substances can be carried out, which penetrate into the pore intermediate spaces of the ceramic material, or form a surface layer. These substances modify the mechanical, thermomechanical, and chemical properties of the ceramics in a suitable manner. For the local adjustment of the properties of the ceramic blanks, however, it is also possible, for example, for ceramic fibres, glass fibres, synthetic fibres, natural fibres, ceramic fibre fabric, glass fibre fabric, synthetic fibre fabric, ceramic rods, glass rods or quartz rods, to be embedded into the mould bodies. By means of the admixture of fibres, for example, it is also possible to adjust the properties of the ceramics not only locally but overall, i.e. “globally” distributed over the entire mould body, for example by uniformly mixing glass fibres, for example, into the entire ceramic suspension before this is used for the slip casting process.

It is also possible, for the local adjustment of the properties of the ceramic blanks, for property gradients to be established which run through the ceramic mould body in a defined orientation which is favourable for the CNC processing.

With regard to the CNC processing in step b), the following possibilities and advantages are derived:

The fixing of the blank for the CNC processing is preferably put into effect by means of a device. The device can fix the blank at several points, or from several sides, or from one side, and thereby ensures adequate mechanical stability even at finely defined regions of the core geometry.

As an alternative, the fixing of the blank for the CNC processing does not take place mechanically by way of a releasable connection, by non-positive, positive, and/or frictional fit, but also by material joining by bonding by means of a suitable joining compound with the device.

Before or after partial performance of the processing steps for the complete core, the fixing of the blank for CNC processing can be temporarily supplemented by an embedding compound which can be removed again, which matches to the contour, or by temporary supports. For connecting the blank to the CNC device, a compound can be used which is specially intended for that purpose, which simultaneously bonds both to the ceramic core material as well as to the metal of the device (typically, for example, steel or aluminium). In addition, the compound should not be subject to attack by the operational media which may possibly be used during the CNC processing (such as compressed air, oils, water, corrosion protection agents). Suitable, for example, is “Nigrin 72111 Performance Full-Spachtel” (filler).

The processing is carried out by means of CNC milling, i.e. in particular by means of a milling tool with defined cutting geometry and/or by CNC grinding, in particular by means of a grinding tool with an abrasive fitting.

The CNC tools are preferably, in accordance with the processing of the abrasive core material with minimum possible tool wear, such as have cutter blades made of polycrystalline diamond (PCD) or cubic boron nitride (CBN). This is due to the fact that possible deviations from the dimension tolerances of the end contour as a consequence of wear-induced changes in the cutting geometry can thereby be avoided or kept to a low degree.

The use in the context of casting technology of a mould produced in accordance with the invention includes, for example, monocrystalline, DS, and equiaxed vacuum precision castings, for the production of moulds of turbine components (only by way of example) made of nickel-based alloys.

A significant advantageous property of the method according to the invention is the moulding being carried out only after the burning of the core material has been finished. This means that a very high degree of dimensional accuracy of the finished cores can be achieved, within tolerances in the range of <+/−0.1 mm of the end contour. The disadvantages which have been described heretofore with traditional core production by means of CIM, in relation to dimensional accuracy and yield, are thereby eliminated. The complete CNC-based attainment of the core end contour also makes it possible, on the basis of a newly-attained geometry, for first cores to be produced with very short run-up times, which are suitable, without restrictions, for the production of commercially exploitable components by precision casting. Slight alterations in an existing component geometry can now be implemented by simply altering the CAM and CNC programs and without the need to alter the devices or the geometry of the blank. The reaction times for such slight alterations are therefore very short. Even more advantageously, the core product is provided with a perceptibly improved material homogeneity and/or additionally with locally adjusted special material properties. The possible type of fixing of the ceramic blank in the CNC device further allows for perceptibly improved quality and yield of the cores produced in accordance with the invention.

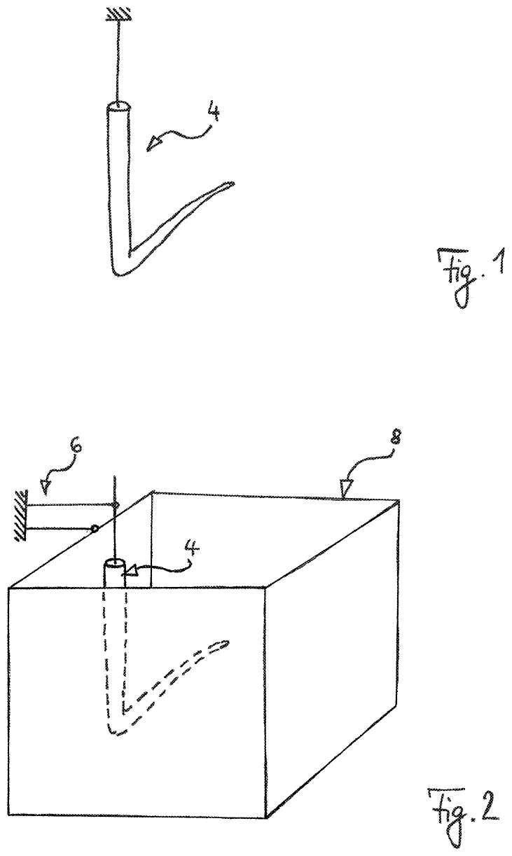

These and other advantages and features of the invention are further described on the basis of the following illustrations of an exemplary embodiment of the invention. In this context, FIG. 1 to FIG. 7 show schematic views of sequential steps of a method according to the invention for producing a casting component which comprises hollow structures.

Making use of a 3D model with digital geometric co-ordinates (not represented) of a casting component 2 (FIG. 7), according to FIG. 1, in a first method step, a core 4 according to the 3D model is produced in a first CNC production method, namely by CNC milling (not represented) from a ceramic core blank 5, which had previously been cast with an oversize in relation to the core 4, in accordance with the geometric co-ordinates by unpressurized casting, namely by means of slip casting. The core blank 5 shown in FIG. 1 is dimensioned in its form with an oversize close to the end contour 4. According to the invention, a core blank is also, and even in particular (not represented), a core blank with a larger and/or irregular oversize, and/or at least in some areas in the form of a geometric base body (or also several and also different forms), such as, for example, a cuboid, cylinder, wedge, sphere, and/or sections of these.

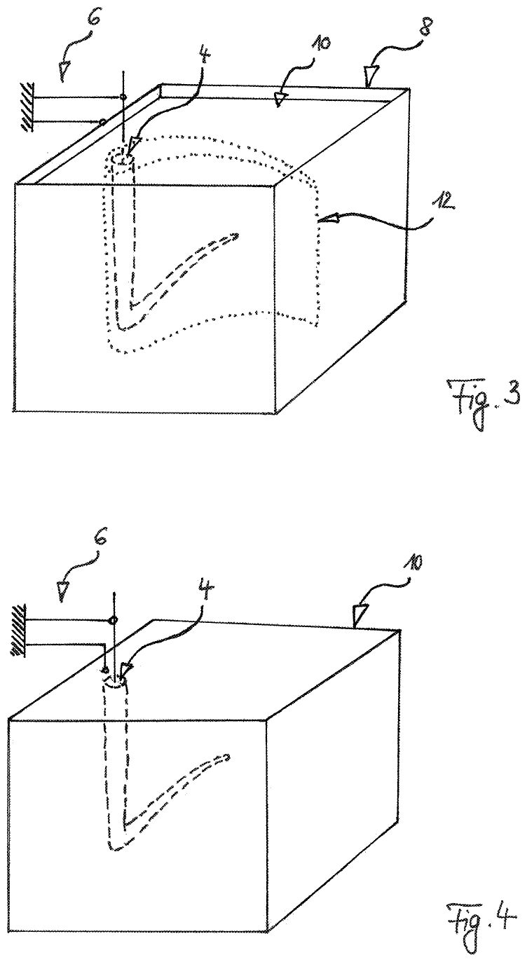

According to FIG. 2, in a next method step, the core 4 is positioned in a processing holding device 6. Arranged around the core is a volume 8, likewise positioned and secured in the processing holding device 6.

According to FIG. 3, in a next method step, model wax 10 is poured into the volume 8, around the core 4. The volume 8 is larger than the cubic dimensions of the casting component 12, and therefore the model wax 10 is poured on all sides until it extends beyond the cubic dimensions of the casting component 12, around the core 4 and into the volume 8. The spatial position of the cubic dimensions of the casting component 12, according to the 3D model (not represented) of the casting component 2 (FIG. 7), is determined by the position of the core 4 in the processing holding device 6.

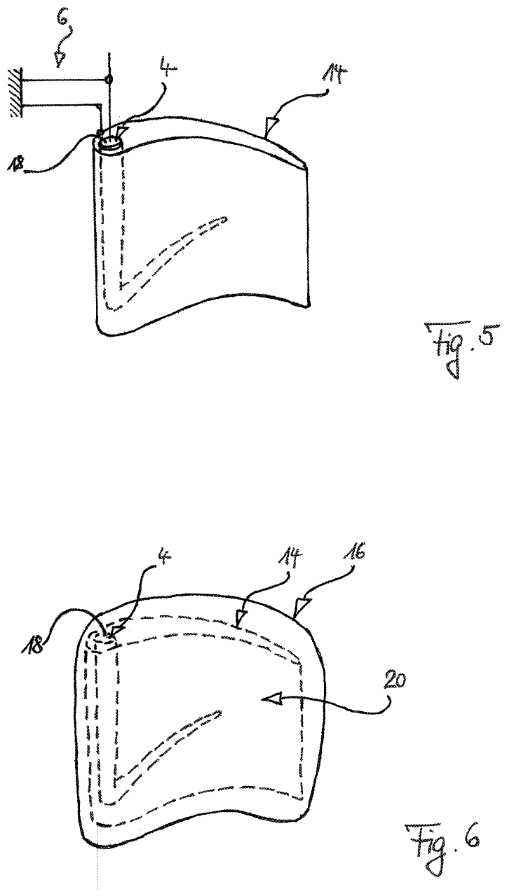

According to FIG. 4, in a next method step, the model material 10 is now allowed to solidify around the core 4, and the volume 8 is removed.

According to FIG. 5, in a next method step, the outer contour of a temporary (lost) model 14 of the casting component 2 (FIG. 7) is produced around the core 4, and specifically from the solidified model material 10 in accordance with the 3D model (not represented) in a second CNC production method, namely again by CNC milling (not represented).

After this step, the wax model 14, with the core 4 inside it, is removed from the processing holding device 6, for example by releasing an adhesive connection or by severing ceramic core material at the transition point to the holding device. The processing holding device 6 is no longer present in the further steps. Instead, the wax model 14 with the core 4 is mounted on what is referred to as a “wax cluster” (not represented), which forms the gating system, and fixes the model 14, 4 by mechanical means. The connection of the core to the ceramic shell is produced by means of what are referred to as “core locks” or “core marks”. These are areas in which the core 4 emerges from the wax model, and which, at the time of the coating with ceramic 16, connects securely to the ceramic shell 16. The positioning between the wax model 14 and core 4 therefore no longer needs to be determined by the processing holding device 6, but by the direct connecting of one of more core marks.

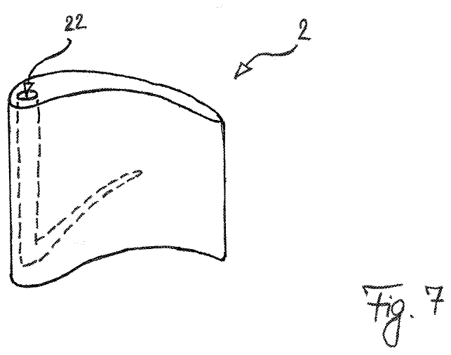

According to FIG. 6, in a next method step, a ceramic mould 16 is therefore applied onto the outer contour of the lost model 14, and in this situation a positioning connection 18 of the ceramic mould 16 is formed by way of a core mark 18 with the core 4, such that the ceramic mould 16 is positioned in relation to the core 4 precisely dimensioned in accordance with the 3D model (not represented) of the casting component 2 (FIG. 7) by the core mark 18. In a next method step, the lost model 14 is removed from the ceramic mould 16 around the core 4 (both of these continue to be held and positioned in relation to one another by the positioning connection 18). A hollow mould 20 is formed between the surface of the ceramic core 4 and the inner surface 14 of the ceramic mould 16. In a next method step, molten metal (not represented) is poured into this. In a next method step, this is allowed to cool.

The molten metal (not represented) solidifies to form the solid casting component 2, which according to FIG. 7 becomes visible in a next method step (by the removal of the ceramic mould 16 and of the ceramic core 4 from the casting component 2), and is therefore available as a component with a hollow structure 22 (corresponding precisely to the core 4) with a high degree of dimensional precision.

1. A method for producing a ceramic core to prepare for the production of a casting having hollow structures, the ceramic core being configured to form, making use of a 3D model of digital geometric co-ordinates of the casting, the method comprises acts of:
a) Unpressurized or low-pressure casting of a ceramic core blank, with an oversize relative to the core according to the geometric co-ordinates; and
b) CNC processing of the core in accordance with the 3D model in a first CNC processing method.

2. A ceramic core for producing a casting having hollow structures, which is configured for the moulding of the ceramic core, making use of a 3D model of digital geometric co-ordinates of the casting using a ceramic mould, the core being produced making use of acts of:
a) Unpressurized or low-pressure casting of a ceramic core blank, and specifically with an oversize relative to the core according to the geometric co-ordinates; and
b) CNC processing of the core according to the 3D model in a first CNC processing method.

3. The method according to claim 1, wherein act a) includes slip casting, pressure slip casting, cold isostatic pressing, hot isostatic pressing, uniaxial pressing, hot casting, low-pressure injection moulding, gel casting, or extrusion.

4. The method according to claim 1, wherein act a) includes CNC milling or a generative manufacturing process, such as, for example, 3D printing, selective laser melting or sintering.

5. The method according to claim 1, further comprising acts of:
c) Positioning the core in a processing holding device;
d) Pouring of model material around the core into a volume larger than the cubic dimensions of the casting, which, according to the 3D model, is spatially determined by the position of the core in the processing holding device, and allowing the model material to solidify;
e) CNC production of an outer contour of a lost model of the casting from the solidified model material around the core, in accordance with the 3D model in a second CNC production method;
f) Applying a ceramic mould onto the outer contour of the lost model and formation of a positioning connection of the ceramic mould with the processing holding device;
g) Removing the lost model from the ceramic mould around the core in the processing holding device;
h) Pouring metal into the ceramic mould around the core;
i) Solidifying of the molten metal to form the solid casting; and
j) Removing the ceramic mould and core from the casting.

6. The method according to claim 2, wherein act a) includes slip casting, pressure slip casting, cold isostatic pressing, hot isostatic pressing, uniaxial pressing, hot casting, low-pressure injection moulding, gel casting, or extrusion.

7. The method according to claim 2, wherein act a) includes CNC milling or a generative manufacturing process, such as, for example, 3D printing, selective laser melting or sintering.

8. The method according to claim 2, further comprising acts of:
c) positioning the core in a processing holding device;
d) pouring of model material around the core into a volume larger than the cubic dimensions of the casting, which, according to the 3D model, is spatially determined by the position of the core in the processing holding device, and allowing the model material to solidify;
e) CNC production of an outer contour of a lost model of the casting from the solidified model material around the core, in accordance with the 3D model in a second CNC production method;
f) applying a ceramic mould onto the outer contour of the lost model and formation of a positioning connection of the ceramic mould with the processing holding device;
g) removing the lost model from the ceramic mould around the core in the processing holding device;
h) pouring metal into the ceramic mould around the core;
i) solidifying of the molten metal to form the solid casting; and
j) removing the ceramic mould and core from the casting.
